(19) United States
(12) Patent Application Publication
(10) Pub. No.: US 2008/0173835 A1
(43) Pub. Date: Jul. 24, 2008

(54) Flow regulator in a compressed gas container

(76) Inventor: Louis D. Tomassetti, Pompano Beach, FL (US)

Correspondence Address: ROBERT M. DOWNEY, P.A., 6751 N. FEDERAL HWY., SUITE 300, BOCA RATON, FL, 33487, US

(21) Appl. No.: 11/657,282

(22) Filed: Jan. 23, 2007

(51) Int. Cl. F16K 31/44

(52) U.S. Cl. 251/118

(57) ABSTRACT

A regulator on a valve mechanism for controlled release of pressurized gas from a container. The valve mechanism includes a valve body mounted within a top of the container, a reciprocating core, a return spring, and a resilient sealing gasket. A tubular stem extends upwardly from the core and through an opening in the top of the container. The gasket maintains an airtight seal between a gas flow passage in the valve body and the stem, thereby preventing release of the gas from the container while the spring holds the valve body in a normally closed position in sealed engagement with the gasket. Forced movement of the stem, against the spring, allows passage of the pressurized gas into an axial bore of the stem for release out from a nozzle tip of a cap fitted to the stem. A flow regulator is fitted to the lower end of the valve body and provides a pinhole opening sized according to the desired gas release flow rate. The pinhole opening restricts gas flow through the valve mechanism, thereby substantially reducing the rate of gas discharge from the nozzle tip when the valve mechanism is open.

### BACKGROUND OF THE INVENTION

1. Field of the Invention

The present invention is directed to a gas flow regulating mechanism and, more particularly, to a regulator on a valve mechanism for the controlled released of pressurized gas from a hand held container.

2. Discussion of the Related Art

Contained sources of various gases are typically found in large metal bottles or tanks that require attachment of a hose and a regulator in order to control the rate of release of the pressurized contents in the metal bottle. The size and weight of bottles filled with pressurized gas makes them difficult to transport. For instance, conventional metal bottles containing a pressurized supply of oxygen are not practical for carrying when performing outdoor activities such as jogging, biking, skiing or other sports activities. For most individuals, a small, handheld container filled with a pressurized supply of oxygen can be convenient for providing oxygen during physical activities, or simply when atmospheric oxygen levels are below normal, such as at higher altitudes or cities with high levels of pollution (smog). However, releasing a pressurized supply of oxygen from a small, handheld container, under a controlled rate of flow can be problematic. While gas mixtures are normally released from small containers with the assistance of a chemical propellant, the use of such propellants is not suited for inhalation. Regulating the rate of release of the pressurized charge of oxygen from a small handheld container is essential to provide a useful supply of contained oxygen that can be easily carried and which is adapted to provide multiple releases of oxygen throughout a physical activity.

### SUMMARY OF THE INVENTION

The present invention is directed to a flow regulator on a valve mechanism for controlled release of pressurized gas from a container. The valve mechanism includes a valve body mounted within a top of the container, a reciprocating core, a return spring, and a resilient sealing gasket. A tubular stem extends upwardly from the core and through an opening in the top of the container. The gasket maintains an airtight seal between a gas flow passage in the valve body and the stem, thereby preventing release of the gas from the container while the spring holds the valve body in a normally closed position in sealed engagement with the gasket. Forced movement of the stem (e.g. downward or tilt movement of the stem), against the spring, allows passage of the pressurized gas into an axial bore of the stem for release out from a nozzle tip of a cap fitted to the stem. A flow regulator is fitted to the lower end of the valve body and provides a pin hole opening sized according to the desired gas release flow rate. The pin hole opening restricts gas flow through the valve mechanism, thereby substantially reducing the rate of gas discharge from the nozzle tip when the valve mechanism is open.

### OBJECTS AND ADVANTAGES OF THE INVENTION

Considering the foregoing, it is a primary object of the present invention to provide a gas flow regulator on a valve mechanism of a container filled with pressurized gas in order to control the release of gas from the container according to a desired flow rate.

It is a further object of the present invention to provide a flow regulator on a valve mechanism of a handheld container filled with a charge of pressurized gas for controlling the release of gas from the container according to a desired flow rate and without the use of chemical propellants.

It is still a further object of the present invention to provide a flow regulator on a container filled with a change of pressurized oxygen for controlling the release of oxygen from the container at a suitable flow rate that enables comfortable inhalation of the oxygen by a user, and further allowing for multiple releases of oxygen at separate times as desired by the user.

### BRIEF DESCRIPTION OF THE DRAWINGS

For a fuller understanding of the nature of the present invention, reference should be made to the following detailed description taken in conjunction with the accompanying drawings in which:

FIG. 1 is an exploded view of a valve mechanism, container top, discharge nozzle and flow regulator of the present invention;

FIG. 2 is a side elevational view, in partial cut-way and phantom showing the regulator and valve mechanism installed to the top of the container with the cap and discharge nozzle separated therefrom;

FIG. 3 is a cross-sectional view showing the discharge nozzle, the valve mechanism and the regulator, and wherein the valve mechanism is closed; and

FIG. 4 is a cross-sectional view showing the discharge nozzle, the valve mechanism and the regulator, and wherein the valve mechanism is open to release gas through the discharge nozzle at a controlled rate of flow.

Like reference numerals refer to like parts throughout the several views of the drawings.

### DETAILED DESCRIPTION OF THE PREFERRED EMBODIMENT

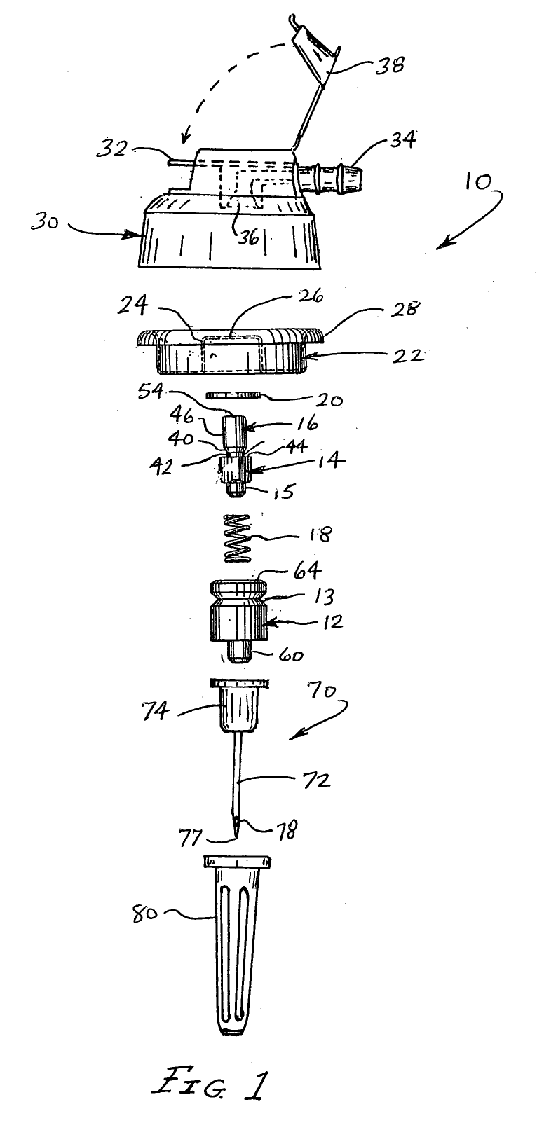

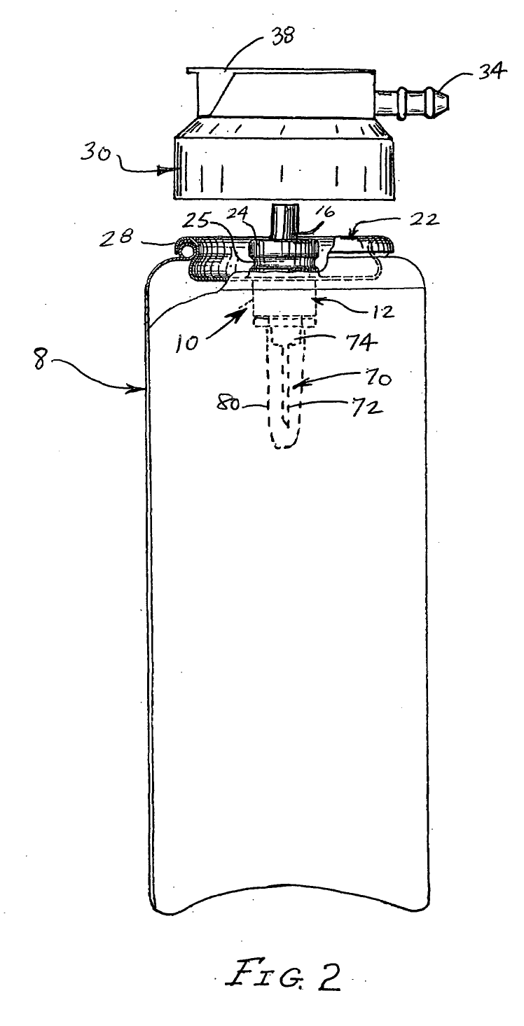

Referring to FIGS. 1 and 2, a valve mechanism 10 for dispensing pressurized gas from a container 8 is shown in exploded view along with the flow regulator of the present invention. The valve mechanism 10 includes a valve body 12, a reciprocal core 14 with a tubular stem 16, a return spring 18, a resilient sealing gasket 20 and a specifically formed container top 22 with a raised central portion 24 within which the valve body 12 is mounted. The resilient gasket 20 is press fit into the underside of the central portion 24 of the container top 22 and provides a gas tight seal around the tubular stem 16 that extends up through an opening 26 in the central portion 24. A cap 30 snaps over the annular rim 28 of the container top 22 and includes an actuator lever 32 with an integrated nozzle 34. The nozzle 34 is in air-flow communication with a flared opening 36 below the actuator lever 32 on the underside of the cap 30. When the cap 30 is fitted to the container top 22, the tubular stem 16 is firmly received within the flared opening 36 on the underside of the cap. A hinged cover 38 closes over the top of the cap 30 and releasably snaps into place to protectively conceal the actuator lever 32 in order to prevent accidental discharge of the pressurized contents (e.g. oxygen). The tubular stem 16 is formed to include a tapered section 40 and a reduced diameter section 42 between the full diameter portion 46 of the tubular stem and a shoulder 44 on the core 14 surrounding the base of the tubular stem 16. The reduced diameter section 42 extends upwardly from the shoulder 44 of the core 14 a distance that is less than the thickness of the gasket 20. The tapered section 40 then extends upwardly and outwardly from the reduced diameter section 42 towards the full diameter portion 46 of the tubular stem.

The gasket 20 is pressed over the stem 16 of the core 14 until it is engaged on the shoulder 44 of the core. The return spring 18 is then pressed onto the bottom projecting portion 15 of the core 14. The inside diameter of the spring 18 is sized to provide a tight engaging fit on the bottom projecting portion 15 of the core 14. Because the gasket 20 is thicker than the height of the reduced diameter section 42 of the tubular stem 16, the gasket 20 is caused to be pressed into sealed engagement with the tapered section 40 when compressed. The gasket 20, when compressed, also seals a transverse, cross axial inlet passage 50 which extends through the reduced diameter section 42 of the tubular stem 16 and into an interior longitudinal axial bore 52 that extends through the interior of the tubular stem 16 to an open top end 54.

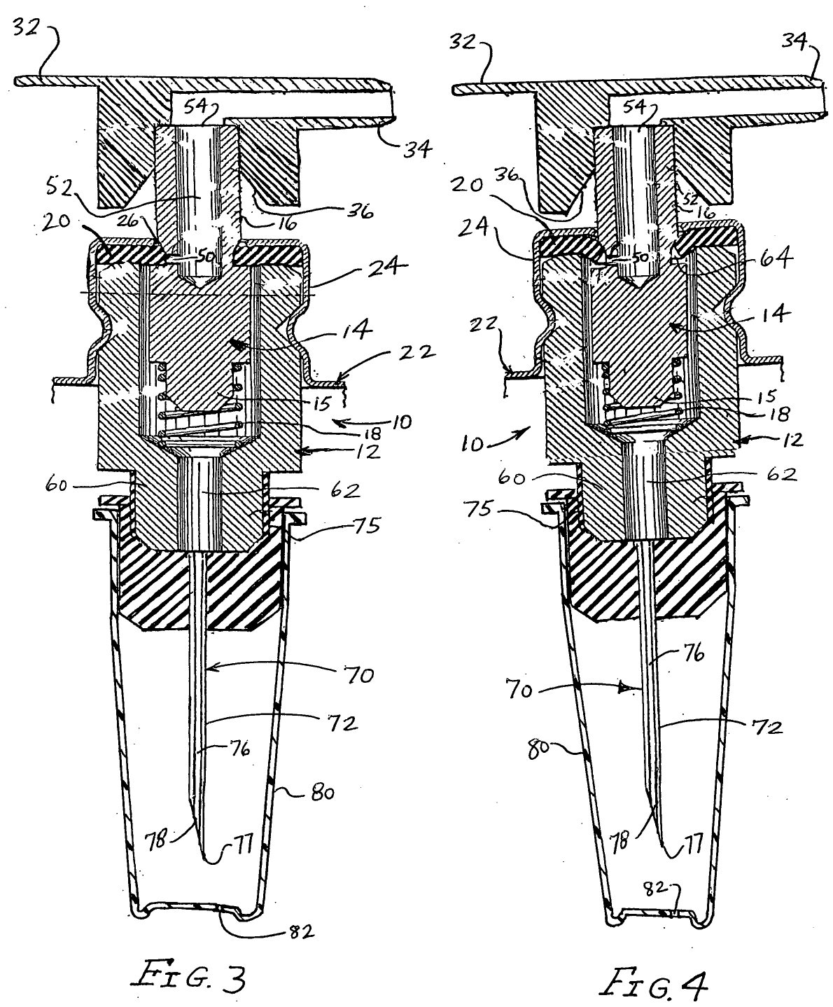

The core 14 and attached spring 18 are received within the valve body 12 so that the spring 18 becomes seated against a shoulder within the valve body. The assembly with the core 14, spring 18 and valve body 12 are then pressed into the central portion 24 on the underside of the container top 22 until the top edge of the valve body 12 is pressed firmly against the gasket 20. An annular crimp 25 is impressed into an annular groove 13 of the valve body 12 in order to secure the valve body 12 to the central portion 24 of the container top 22. A downwardly depending stub member 60 on the bottom of the valve body 12 is provided with an axial longitudinal bore 62 that communicates with an open top 64 of the valve body 12, thereby allowing flow of gas (e.g., oxygen) therethrough and around the core 14 that is received within the interior of the valve body (see FIGS. 3 and 4).

The flow regulator 70 for restricting the gas release rate through the valve mechanism 10 includes a needle 72. The needle 72 has a hub 74 with an inner annular surface 75 that is sized for snug fitted receipt of the stub portion 60 of the valve body 12 to effectively secure the needle 72 and hub 74 to the bottom side of the valve body 12. The needle 72 has a longitudinal axial bore 76 that communicates with the axial bore 62 formed through the stub member 60, thereby permitting gas to flow through the bottom opening 78 of the needle 72 and upwardly through the valve body 12. A protective cap 80 may be fitted over the hub 74 to conceal the needle 72. While not essential, the protective cap 80 may allow for easier assembly and avoid puncture injury by the needle tip 77. A pinhole 82 in the bottom of the protective cap 80 allows gas flow communication between an interior chamber 9 of the container 8 and the open bottom end 78 of the needle 72 so that pressurized gas contents within the container are able to flow thorough the pinhole 82 of the protective cab 80, upwardly through the needle 72 and up through the valve body 12. The reduced size of the longitudinal axial bore passage 76 through the needle 72 restricts flow of pressurized gas into the valve body 12, thereby providing a flow regulator. Thus, the needle 72 provides the function of limiting the gas (e.g., oxygen) flow rate by reducing the volume of gas per unit of time that can freely flow through the valve body 12 when the valve mechanism is open.

As seen in FIGS. 3 and 4, when the valve mechanism 10 and flow regulator 70 are fully assembled, and the cap 30 is fitted to the top of the container 8, the tubular stem 16 is firmly received within the flared opening 36 below the actuator lever 32 on the cap 30. In operation, the hinged cover 38 is first lifted and swung open, as seen in FIG. 1, to allow access to the actuator lever 32. Then, by depressing down on the actuator lever 32, the tubular stem 16 and core 14 of the valve mechanism 10 are moved downwardly, against the resistance of the spring 18. When the core 14 is moved downwardly, the tapered section 40 on the neck of the tubular stem 16 urges the central portion of the gasket 20 downwardly, causing the central portion of the gasket 20 to flex. This flexing action causes the shoulder 44 of the core 14 to break its seal with the underside of the gasket 20, creating an annular clearance opening around the base of the tubular stem 16, and thereby exposing the inlet passage 50 that extends through the reduced diameter section 42 of the tubular stem 16. When the valve mechanism 10 is operated to the open condition, as described above, gas contained under pressure within the container 8 interior chamber 9 is able to flow through the needle 72, upwardly through the valve body 12, around the core 14, through the inlet passage 50 and out through the open top 54 of the tubular stem 16, and finally exiting through the nozzle 34 on the cap 30.

When downward pressure on the actuator lever 32 is released, the spring urges the core 14 and tubular stem 16 upwardly within the central portion 24 of the container top 22, causing the gasket 20 to return to its relaxed state, as seen in FIG. 3. In this position, the gasket 20 is in sealed engagement with the shoulder 44 of the core 14 and is also sealed over the inlet passage 50 in the reduced diameter section 42 of the tubular stem 16. The gasket 20 also seals against the tapered section 40 of the tubular stem, preventing gas from escaping out through the top 22 of the container around the exterior of the tubular stem 16.

When the valve mechanism 10 is operated to the open position, as seen in FIG. 4, by pushing downwardly on the actuator lever 32, the charge of compressed gas within the container 8 is released under controlled flow from the discharge nozzle 34. As described above, the narrow axial bore 76 extending through the needle 72 limits the flow rate of gas into the valve body 12 and out from the nozzle 34, in a regulating manner, so that the charge of compressed gas within the container 8 does not quickly rush out from the discharge nozzle 34 when the valve mechanism 10 is open. This allows for prolonged use of the compressed gas contents (e.g., oxygen) for multiple discharges over an extended life of the product.

While the present invention has been shown and described in accordance with preferred and practical embodiments thereof, it is recognized that departures from the instant disclosure are fully contemplated within the spirit and scope of the invention.

What is claimed is:

1. A valve assembly on a container for releasing a pressurized charge of gas from the container, said valve assembly comprising:
a valve body having a gas flow passage extending therethrough;
a valve stem including an axial passage extending therethrough and communicating with said gas flow passage of said valve body, and said valve stem being operatively moveable relative to said valve body between a closed, sealed position preventing gas flow through said axial passage and release of the pressurized charge of gas from said valve assembly, and an open position allowing gas to flow from said valve body and through said axial passage of said valve stem, wherein gas is released from said valve assembly; and
a flow regulator attached to said valve body in communication with said gas flow passage, and said flow regulator being structured and disposed for restricting flow of the pressurized charge of gas through said valve body to control the rate of release of the pressurized charge of gas from said valve assembly.

2. The valve assembly as recited in claim 1 wherein said flow regulator includes a needle with a longitudinal axial bore communicating with said gas flow passage and an open end communicating with said longitudinal axial bore and the pressurized charge of gas, said open end and said longitudinal axial bore being smaller in cross-sectional dimension then said gas flow passage, wherein flow of the pressurized charge of gas is restricted by the smaller dimensioned longitudinal axial bore prior to entering said gas flow passage.

3. The valve assembly as recited in claim 2 wherein said gas flow regulator further includes a hub attached to said needle, and said hub being structured and disposed for attachment to said valve body.

4. The valve assembly as recited in claim 3 further comprising:
a protective cap attached to said hub and covering said needle, and said protective cap including a pinhole opening communicating between the pressurized charge of gas and said open end of said needle.

5. A valve assembly on a container for releasing a pressurized charge of gas from the container, said valve assembly comprising:
a valve mechanism operable between a closed position to prevent release of the pressurized charge of gas from the container and an open position to release the pressurized charge of gas from the container; and
a flow regulator on said valve mechanism, and said flow regulator including a passage that is structured and disposed for restricting flow of the pressurized charge of gas through said valve mechanism to control the rate of release of the pressurized charge of gas from the valve assembly.

6. The valve assembly as recited in claim 5 wherein said flow regulator includes a needle with a longitudinal axial bore communicating with said valve mechanism, and said needle further including an open end communicating with said longitudinal axial bore and the pressurized charge of gas within the container, and said open end and said longitudinal axial bore being sized, structured and configured for restricting flow of the pressurized charge of gas into said valve mechanism.

7. The assembly as recited in claim 6 wherein said regulator further includes a hub attached to said needle, and said hub being structured and disposed for attachment to said valve body.

8. The valve assembly as recited in claim 7 further comprising:
a protective cap attached to said hub and covering said needle, and said protective cap including a pinhole opening communicating between the pressurized charge of gas and said open end of said needle.
